(19) United States
(12) Patent Application Publication
(10) Pub. No.: US 2020/0249383 A1
(43) Pub. Date: Aug. 6, 2020

(54) WIRE GRID POLARIZERS AND METHODS OF MAKING THE SAME

(71) Applicant: Corning Incorporated, Corning, NY (US)

(72) Inventor: Michael Francis Foley, Avon, CT (US)

(21) Appl. No.: 15/776,250

(22) PCT Filed: Nov. 17, 2016
(86) PCT No.: PCT/US16/62493

§ 371 Date: May 15, 2018

Related U.S. Application Data
(60) Provisional application No. 62/258,777, filed on Nov. 23, 2015.

(51) Int. Cl. G02B 5/30; B29C 59/04; B29C 35/10

(52) U.S. Cl. CPC G02B 5/3058; B29C 2035/0827; B29C 35/10; B29C 59/046

(57) ABSTRACT

A wire grid polarizer includes a thin and thus flexible glass substrate (102), and an optical resin layer (120) positioned over at least a portion of the glass substrate, the optical resin layer including, a base portion and a plurality of ribs extending from the base portion, where individual ribs of the plurality of ribs are spaced apart from one another by a pitch that is between about 40 nm and 240 nm, and where the individual ribs of the plurality of ribs define gaps between adjacent ribs and none of the gaps are greater than 10 microns over a length of the wire grid polarizer.

This application claims the benefit of priority under 35 U.S.C. §119 of U.S. Provisional Application No. 62/258,777, filed on Nov. 23, 2015, the content of which is relied upon and incorporated herein by reference in its entirety.

### BACKGROUND

### Field

The present specification relates generally to wire grid polarizers, and more particularly to seamless wire grid polarizers. Methods and apparatuses including tooling for fabricating seamless wire grid polarizers are also described.

### Technical Background

Liquid Crystal Displays (LCD) include liquid crystals that selectively pass light through the LCD. In operation, LCDs may include a light or backlight that produces and directs light toward pixels including the liquid crystal material. The light or backlight may produce white light, i.e., light including a combination of different wavelengths in the electromagnetic spectrum. The light from the backlight may be polarized prior to reaching individual pixels of the LCD, and the liquid crystal material of the individual pixels may be selectively oriented to allow polarized light from the backlight to pass through the individual pixels or may be selectively oriented to prevent the polarized light from passing through the individual pixels.

LCDs may include a polarizing filter that absorbs wavelengths of the light from the backlight, the absorbed wavelengths representing wasted energy from the backlight. Some polarizing filters may reflect wavelengths of light that do not pass through the filter so that the energy associated with the reflected wavelengths of light may be recycled. Conventional reflective polarizing filters may be formed from multiple layers of bi-axially oriented film, or may be formed with seamed tooling as part of a micro-replication process. However, reflective polarizing filters formed from multiple layers of film are costly to produce and may be susceptible to thermal gradients that result in deformation of the filter, which may limit the size of the reflective polarizing filter, and subsequently the size of the LCD. For polarizing filters formed with seamed tooling, visible discontinuities may be formed in the polarizing filter by the seams of the tooling, which may limit the size of the reflective polarizing filter, and subsequently the LCD.

Accordingly, there is a need for alternative apparatuses and methods for fabricating seamless wire grid reflective polarizers.

### SUMMARY

In one embodiment, a wire grid polarizer includes a glass web, an optical resin layer positioned over at least a portion of the glass web, the optical resin layer including a base portion and a plurality of ribs extending from the base portion, where individual ribs of the plurality of ribs are spaced apart from one another by a pitch that is between about 40 nanometers (nm) and 240 nm, and where the individual ribs of the plurality of ribs define gaps between adjacent ribs and each gap is equal to or less than 10 micrometers (μm) over a length of the wire grid polarizer. The ribs may comprise, for example, a linear array of parallel ribs.

In another embodiment, a method for forming a wire grid polarizer includes moving a glass web in a conveyance direction, applying an optical resin layer over the glass web, contacting the optical resin layer with an outer circumference of a replication roller including a plurality of projections extending around at least a portion of the outer circumference, and curing the optical resin layer.

In another embodiment, a replication roller includes an outer circumference and a plurality of projections extending around the outer circumference of the replication roller, where individual projections of the plurality of projections are spaced apart from one another by a pitch that is between about 40 nm and 240 nm. The individual projections of the plurality of projections define gaps between adjacent projections, and none of the gaps are greater than 10 μm around the outer circumference of the replication roller. The projections may include, for example, an array of linear projections, for example linear projections extending parallel to an axis of rotation of the roller.

In yet another embodiment, a method for forming a replication roller includes coating an outer circumference of a roller with a photoresist layer, exposing portions of the photoresist layer to a first intensity of electromagnetic radiation and exposing other portions of the photoresist layer to a second intensity of electromagnetic radiation less than the first intensity of electromagnetic radiation.

Additional features and advantages of the embodiments will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a wire grid polarizer according to one or more embodiments shown and described herein;

FIG. 2 schematically depicts a cross-section of the wire grid polarizer of FIG. 1 along section 2-2 according to one or more embodiments shown and described herein;

FIG. 3 schematically depicts a glass production apparatus including a replicating roller according one or more embodiments shown and described herein;

FIG. 4 schematically depicts a side view of the replicating roller and a portion of the glass production apparatus of FIG. 3 according to one or more embodiments shown and described herein;

FIG. 5 schematically depicts an enlarged side view of the replicating roller of FIG. 4 according to one or more embodiments shown and described herein;

FIG. 6 schematically depicts a phase-shift mask and an outer circumference of the replication roller of FIG. 4 according to one or more embodiments shown and described herein;

FIG. 7A schematically depicts the phase mask and a section of the outer circumference of the replication roller of FIG. 6 according to one or more embodiments shown and described herein; and

FIG. 7B schematically depicts a representation of the intensity and pitch of wavelengths of energy passed through the phase mask and incident on the outer circumference of the replication roller of FIG. 7A according to one or more embodiments shown and described herein.

### DETAILED DESCRIPTION

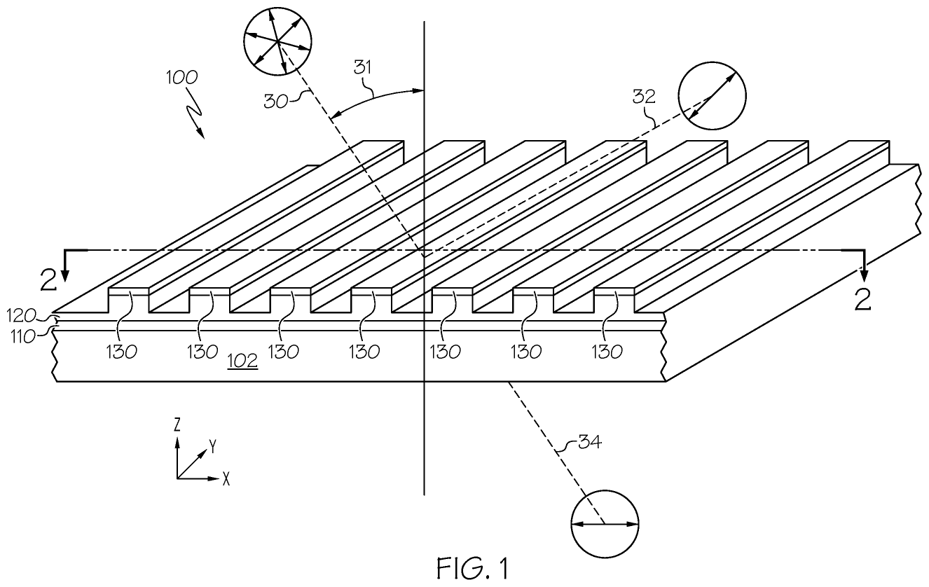

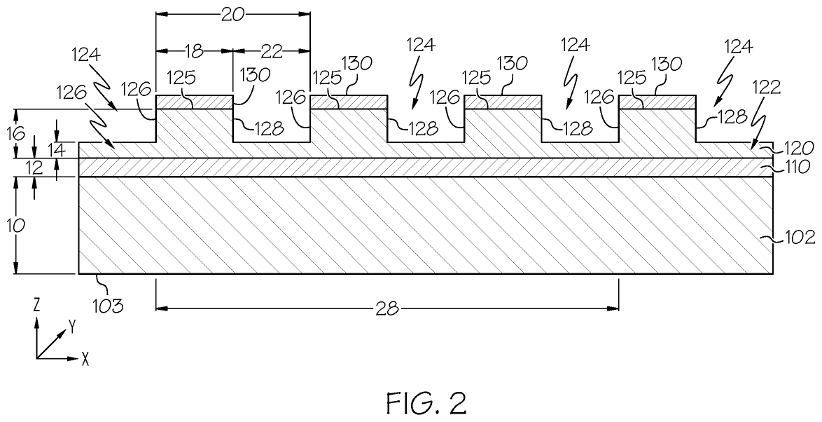

Reference will now be made in detail to embodiments of apparatuses and methods for fabricating a wire grid polarizer. Whenever possible, the same reference numerals will be used throughout the drawings to refer to the same or like parts. FIGS. 1 and 2 depict a wire grid polarizer on a glass web. Wire grid polarizers may be fabricated on a glass web by depositing an optical resin layer on the glass web and forming ribs on the optical resin layer with a replication roller. Reflectors may later be deposited on the ribs to form the wire grid polarizer. In embodiments, the replication roller includes a plurality of projections that extend around the outer circumference of the replication roller. Through contact with the optical resin layer, the replication roller may be utilized to continuously form ribs onto the optical resin layer, which may allow for the continuous fabrication of wire grid polarizers. A phase-mask lithography process may be utilized to form the plurality of projections on the outer circumference of the wire grid polarizer such that a width of and a pitch between individual projections of the plurality of projections on the replication roller correspond to the ribs of the wire grid polarizer. By utilizing a replication roller formed through a phase-mask lithography process, tolerances with regard to dimensions of the ribs of the wire grid polarizer and the flatness of the wire grid polarizer may be controlled, thereby reducing non-compliant parts and manufacturing costs. Wire grid polarizers and methods and apparatuses for continuously fabricating wire grid polarizers will be described in more detail herein with specific reference to the appended drawings.

As used herein, the term “longitudinal direction” refers to the forward-rearward direction of the wire grid polarizer and the components used to fabricate the wire grid polarizer (i.e., in the +/−X-direction as depicted). The term “lateral direction” refers to the cross-direction of the wire grid polarizer and the components used to fabricate the wire grid polarizer (i.e., in the +/−Y-direction as depicted), and is transverse to the longitudinal direction. The term “vertical direction” refers to the upward-downward direction of the wire grid polarizer and the components used to fabricate the wire grid polarizer (i.e., in the +/−Z-direction as depicted).

Ranges can be expressed herein as from “about” one particular value, and/or to “about” another particular value. When such a range is expressed, another embodiment includes from the one particular value and/or to the other particular value. Similarly, when values are expressed as approximations, for example by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

Referring to FIG. 1, a wire grid polarizer 100 is schematically depicted. The wire grid polarizer 100 includes a glass web 102, an optical resin layer 120 positioned on the glass web 102, and a plurality of reflectors 130 positioned on the optical resin layer 120. The wire grid polarizer 100 may optionally include a tie coat layer 110 positioned between the optical resin layer 120 and the glass web 102 to promote adhesion between the optical resin layer 120 and the glass web 102.

The glass web 102, the tie coat layer 110, and the optical resin layer 120 include materials that are transparent or light-transmissive. For example, in embodiments, the glass web 102, the tie coat layer 110, and the optical resin layer 120 permit at least an 85% optical transmission of wavelengths across 85% of the visible spectrum. In embodiments, the glass web 102 includes a glass web that may be formed through a downdraw process, as will be described in greater detail herein. The glass web 102 may be formed from a glass material having a Young's modulus of between about 70 gigapascals (GPa) and about 80 GPa and a coefficient of thermal expansion (CTE) between about 1 part per million/degree Celsius (ppm/° C.) and about 5 ppm/° C. By forming the glass web 102 from a glass material having a CTE between about 1 ppm/° C. and about 5 ppm/° C., the glass web 102 may maintain the dimensional stability of the wire grid polarizer 100 when exposed to a temperature gradient, such as when the wire grid polarizer 100 is utilized as a component of an LCD.

In embodiments, the tie coat layer 110 may include materials such as silicone, siloxane-based materials, or the like. The optical resin layer 120 may be formed from a thermoplastic or thermoset such as poly(methyl methacrylate), polyurethane, polycarbonate, or the like, and may include ultraviolet cured thermoset materials which have a low viscosity prior to curing.

The plurality of reflectors 130 can include reflective materials that inhibit transmission of light. In embodiments, the reflectors 130 may be formed from a metallic coating, such as aluminum or the like. The plurality of reflectors 130 extend across the wire grid polarizer 100 in the lateral direction, and individual reflectors of the plurality of reflectors 130 are separated from one another in the longitudinal direction.

Referring to FIG. 2, a section view of the wire grid polarizer 100 is depicted along section 2-2 of FIG. 1. The glass web 102 includes a planar web having a bottom surface 103, which may be referred to as the backside of the wire grid polarizer 100 a thickness 10 evaluated in the vertical direction. In embodiments, the thickness 10 can be from about 100 μm to about 200 μm, inclusive of the endpoints. A relatively small thickness 10 evaluated in the vertical direction can result in the glass web 102 being flexible such that the glass web 102 may be wound on a roll or spool, which may allow for the wire grid polarizer 100 to be processed and fabricated in a continuous conveyance or a roll-to-roll process, as will be described in greater detail herein.

The optional tie coat layer 110, when present, is positioned between the glass web 102 and the optical resin layer 120. Tie coat layer 110 comprises a thickness 12 evaluated in the vertical direction. In embodiments, the thickness 12 of the tie coat layer 110 can be from about 0.1 μm to about 2.0 μm, inclusive of the endpoints. In some embodiments, the thickness 12 of the tie coat layer 110 may be in a range from about 0.7 μm to about 0.8 μm, inclusive of the end points.

The optical resin layer 120 is positioned on the glass web 102 and/or on the optional tie coat layer 110, and includes a base portion 122 and a plurality of ribs 124 that extend orthogonally upward from the base portion 122, i.e., in the vertical direction in FIG. 2. The optical resin layer 120 includes a thickness 14 at the base portion 122 evaluated in the vertical direction, and individual ribs of the plurality of ribs 124 each comprise a thickness 16 evaluated in the vertical direction, where the thickness 16 is greater than the thickness 14. In embodiments, the thickness 14 at the base portion 122 is about 100 nm, and the thickness 16 at the plurality of ribs 124 is about 200 nm. In other words, in some embodiments, individual ribs of the plurality of ribs 124 can extend 100 nm above the base portion 122 in the vertical direction. In some embodiments, the thickness 14 at the base portion 122 is between about 95 nm and about 105 nm, and the thickness 16 at the plurality of ribs 124 is between about 190 nm and 210 nm. In other embodiments, the thickness 14 at the base portion 122 is between about 90 nm and about 110 nm, and the thickness 16 at the plurality of ribs 124 is between about 180 nm and 220 nm.

In embodiments, the thickness 16 at individual ribs of the plurality of ribs 124, the thickness 12 of the tie coat layer 110, and the thickness 10 of the glass web 102 are generally uniform, evaluated along a length 28 of the wire grid polarizer 100 in the longitudinal direction. In particular, along a length 28 of the wire grid polarizer 100, the plurality of ribs 124, the tie coat layer 110, and the glass web 102 may have a flatness tolerance of less than about 1 μm evaluated between the bottom surface 103 of the glass web 102 and a top surface 125 of the plurality of ribs 124. In embodiments, the length 28 of the wire grid polarizer 100 along which the flatness tolerance is evaluated may be greater than about 127 centimeters (cm). In other embodiments, the length 28 of the wire grid polarizer 100 along which the flatness tolerance is evaluated may be greater than about 152 cm. By limiting deviations in flatness of the wire grid polarizer 100, visible defects caused by flatness deviations in the wire grid polarizer 100, such as defects that may be visible when the wire grid polarizer 100 is utilized in an LCD, may be reduced.

Individual ribs of the plurality of ribs 124 include a front side 126 and a rear side 128 that is spaced apart from the front side 126 in the longitudinal direction. Individual ribs of the plurality of ribs 124 have a width 18 evaluated between the front side 126 and the rear side 128 in the longitudinal direction, and each rib of the plurality of ribs 124 is separated from an adjacent rib by a pitch 20 evaluated between the respective front sides 126 of subsequent adjacent ribs 124 in the longitudinal direction. In some embodiments, the pitch 20 between individual ribs of the plurality of ribs 124 is about 200 nm and the width 18 of individual ribs of the plurality of ribs 124 is about 100 nm. In other words, the width 18 of individual ribs of the plurality of ribs 124 is about the same as a gap 22 between individual ribs of the plurality of ribs 124.

In some embodiments, the width 18 of individual ribs of the plurality of ribs 124 is between about 20 nm and about 120 nm, and the pitch 20 between individual ribs of the plurality of ribs 124 is between about 40 nm and about 240 nm, inclusive of the endpoints. The pitch 20 between individual ribs and the width 18 of the individual ribs may be selected such that a ratio between the width 18 and the pitch 20 is about 1:2. By selecting the width 18 and the pitch 20 such that the ratio between the width 18 and the pitch 20 is about 1:2, the wire grid polarizer 100 may provide a desirable contrast ratio when the wire grid polarizer is utilized in an LCD. While in the embodiment depicted in FIG. 2 the plurality of ribs 124 are depicted as including a rectangular cross-section or square shape, it should be understood that the plurality of ribs 124 may include any suitable shape to assist in selectively polarizing light incident on the wire grid polarizer 100, including, without limitation, a wave shape or triangular shape.

In embodiments, individual ribs of the plurality of ribs 124 are periodically spaced, and the pitches 20 and the gaps 22 between individual ribs of the plurality of ribs 124 are generally uniform when evaluated along a length 28 of the wire grid polarizer 100 in the longitudinal direction. For example, in embodiments, the gaps 22 may have a tolerance such that each of the gaps 22 between adjacent ribs are less than or equal to about 10 μm, evaluated along a length 28 of the wire grid polarizer 100. In some embodiments, the gaps 22 have a tolerance such that each of the gaps 22 between adjacent ribs may be less than or equal to about 1 μm, evaluated along a length 28 of the wire grid polarizer 100. In other embodiments, the gaps 22 have a tolerance such that each of the gaps 22 between adjacent ribs are less than or equal to about 0.5 μm, evaluated along a length 28 of the wire grid polarizer 100.

Along the length 28 of the wire grid polarizer, gaps 22 between individual ribs of the plurality of ribs 124 may also be generally uniform along each individual gap 22 in the lateral direction, such that the plurality of ribs 124 are generally parallel. For example in one embodiment, the gaps 22 may have a tolerance such that no gap 22 has any portion of the gap 22 with an average width greater than about 10 μm, where the portion with the average width greater than about 10 μm extends more than about 10 μm in the lateral direction. In another embodiment, the gaps 22 may have a tolerance such that no gap 22 has any portion of the gap 22 with an average width greater than about 1 μm, where the portion with the average width greater than about 1 μm extends more than about 10 μm in the lateral direction. In another embodiment, the gaps 22 may have a tolerance such that no gap 22 has any portion of the gap 22 with an average width greater than about 0.5 μm, where the portion with the average width greater than about 0.5 μm extends more than about 10 μm in the lateral direction.

In embodiments, the length 28 of the wire grid polarizer 100 over which the tolerance of the gaps 22 is evaluated may be greater than about 127 cm. In other embodiments, the length 28 of the wire grid polarizer 100 over which the tolerance of the gaps 22 is evaluated may be greater than about 152 cm. By limiting the size of the gaps 22 between adjacent ribs of the plurality of ribs 124, visible defects caused by deviations in the size of the gaps 22 in the wire grid polarizer 100 may be reduced when the wire grid polarizer 100 is utilized as component of an LCD.

As described above, the plurality of reflectors 130 are positioned on the plurality of ribs 124 of the optical resin layer. The plurality of reflectors 130 may selectively allow waves of light with an e-field perpendicular to the plurality of reflectors 130 to pass through the wire grid polarizer 100, while reflecting waves of light that have an e-field parallel to the plurality of reflectors 130.

Referring again to FIG. 1, in operation, unpolarized light 30 is incident on the wire grid polarizer 100 at an incident angle 31. It should be understood that the incident angle 31 may include any suitable angle, and the incident angle 31 may be zero, i.e., the unpolarized light 30 may be normal to the surface of the wire grid polarizer 100. A reflected portion 32 of the unpolarized light 30 is reflected from the wire grid polarizer 100, while a transmitted portion 34 of the unpolarized light 30 is transmitted through the wire grid polarizer 100. The reflected portion 32 may include light waves with an e-field parallel to the plurality of reflectors 130, while the transmitted portion includes light waves with an e-field perpendicular to the plurality of reflectors 130. In this way, the wire grid polarizer 100 may selectively allow transmission of polarized light, which may subsequently be directed toward a pixel of a LCD display when the wire grid polarizer 100 is utilized as a component of a LCD.

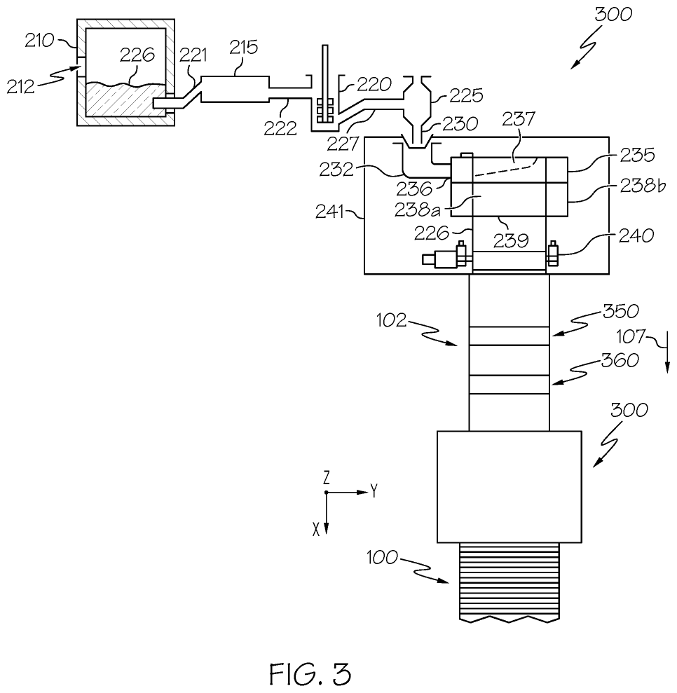

Methods of manufacturing the wire grid polarizer 100 of FIGS. 1 and 2 will now be described with reference to FIGS. 3-6B.

In embodiments, the glass web 102 may include a glass ribbon. While glass is generally known as a brittle material, inflexible and prone to scratching, chipping and fracture, glass having a thin cross section (e.g. thickness) can in fact be quite flexible. Glass in long thin sheets or webs can be wound and un-wound from rolls, much like paper or plastic film.

Referring initially to FIG. 3, a glass production apparatus 200 may include a melting vessel 210, a fining vessel 215, a mixing vessel 220, a delivery vessel 225, and a fusion draw machine (FDM) 241. Glass batch materials are introduced into the melting vessel 210 as indicated by arrow 212. The batch materials are melted to form molten glass 226. The fining vessel 215 has a high temperature processing area that receives the molten glass 226 from the melting vessel 210 through connecting tube 221 and bubbles are removed from the molten glass 226 in the fining vessel 215. The fining vessel 215 is in fluid communication with the mixing vessel 220 by a connecting tube 222. The mixing vessel 220 is in fluid communication with the delivery vessel 225 by a connecting tube 227.

The delivery vessel 225 supplies the molten glass 226 through a downcomer 230 into the FDM 241. The FDM 241 comprises an inlet 232, a forming vessel 235, and a pull roll assembly 240. As shown in FIG. 10, the molten glass 226 from the downcomer 230 flows into the inlet 232 which leads to the forming vessel 235. The forming vessel 235 includes an opening 236 that receives the molten glass 226 which flows into a trough 237 and then overflows and runs down two sides 238a and 238b before fusing together below a root 239 at which the sides 238a and 238b converge. The two overflow flows of molten glass 226 rejoin (e.g., fuse) before being drawn downward by the pull roll assembly 240 to form the glass web 102, that in the embodiment depicted in FIG. 3 is a glass web. As the glass web remains in a viscous or visco-elastic state, the glass web is prone to dimensional variations. To control the dimensional variation of the glass web, the pull roll assembly 240 “draws” the glass web by applying tension to the glass web as the glass web continues to form from the forming vessel 235. The term “draw,” as used herein refers to moving the glass web through a glass production apparatus 200 while the glass web is in a viscous or visco-elastic state. The glass web goes through a visco-elastic transition in a “setting zone” in which the stress and flatness are set into the glass web, and the glass web transitions to an elastic state.

While a fusion draw machine as described herein may be utilized to form the glass web 102, other processes and methods of forming a glass web are contemplated. For example and without limitation, the glass web may also be formed using a “redraw” process or using a float glass method. In the “redraw” process (not depicted), heat may be applied to a surface of a “preform” glass sheet. As the “preform” glass sheet is heated, the “preform” glass sheet may be drawn to reduce a thickness of the “preform” glass sheet to form the glass web. In the float glass method (not depicted), molten glass may be “floated” over a bed of molten metal, for example molten tin. As the molten glass floats over the molten metal, the molten glass spreads across the molten metal to form a glass ribbon, where the glass ribbon has a substantially uniform thickness. The glass ribbon may then be drawn from the bed of molten metal and cooled to form the glass web.

Still referring to FIG. 3, as the glass web exits the pull roll assembly 240, the glass web is in an elastic state. In one embodiment, after the glass web 102 passes through the setting zone, the glass web 102 moves in a conveyance direction 107 and is processed to fabricate the wire grid polarizer 100. Alternatively, after the glass web 102 passes through the setting zone, the glass web 102 may be taken up by a spool (not depicted), and the wire grid polarizer 100 may be formed in a subsequent conveyance process, such as a roll-to-roll process. In a roll-to-roll process, the glass web 102 may be unwound from an input spool, conveyed in a conveyance direction 107 and processed to form the wire grid polarizer 100, and then rewound about an output spool.

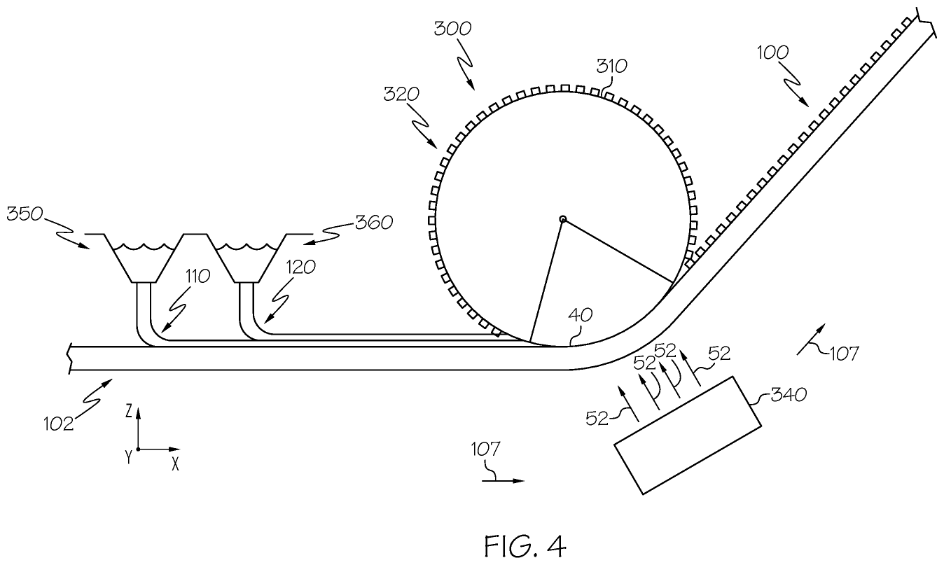

Referring now to FIG. 4, as the glass web 102 moves in the conveyance direction 107, an applicator 350 applies the tie coat layer 110 to the top surface (opposite bottom surface 103) of the glass web 102. Subsequent to the application of the tie coat layer 110 to the glass web 102, another applicator 360 applies a resin that will form the optical resin layer 120 on the tie coat layer 110. As shown in FIG. 4, the tie coat layer 110 and the optical resin layer 120 may be applied continuously to the glass web 102 as the glass web 102 is conveyed in the conveyance direction 107.

Once the tie coat layer 110 and the optical resin layer 120 have been applied to the glass web 102, the glass web 102 is conveyed to a replication roller 300. The replication roller 300 may have a cylindrical shape and include an outer circumference 310 that contacts the optical resin layer 120. The outer circumference 310 of the replication roller 300 includes a plurality of projections 320 that extend radially outward from the outer circumference 310, and that extend around the outer circumference 310 of the replication roller 300.

As the glass web 102 is conveyed in the conveyance direction 107, the optical resin layer 120 positioned on the glass web 102 is brought into contact with the outer circumference 310 of the replication roller 300. The replication roller 300 is positioned such that individual projections of the plurality of projections 320 are pressed into the optical resin layer 120 as the glass web 102 moves in the conveyance direction 107. In embodiments, the replication roller 300 is freewheeling and may rotate as a result of contact between the replication roller 300 and the optical resin layer 120 as the glass web 102 is conveyed in the conveyance direction 107. In other embodiments, the replication roller 300 may be driven by a motive force, such as by a motor or the like, and may be rotated by the motive force as the glass web 102 is conveyed in the conveyance direction 107.

As the replication roller 300 contacts and engages the optical resin layer 120, the glass web 102 may be directed around at least a portion of the outer circumference 310 of the replication roller 300 such that the replication roller 300 contacts and engages the optical resin layer 120 along an arc length 40 of the outer circumference 310. By directing the glass web 102 around at least a portion of the outer circumference 310, the arc length 40 in contact with the optical resin layer 120 is greater than if the glass web 102 is not directed around at least a portion of the outer circumference 310. While FIG. 4 depicts the glass web 102 being directed from a conveyance direction 107 that extends primarily in a longitudinal direction to extending upward in a vertical direction, it should be understood that the glass web 102 may be directed in any suitable direction such that the glass web is directed around and contacts an arc length of the outer circumference 310 of the replication roller 300, the arc length being less than the entire outer circumference 310. The glass web 102 may be directed around the outer circumference 310 of the replication roller 300 with various non-contact devices, such as an air-bar, air bearings, or the like.

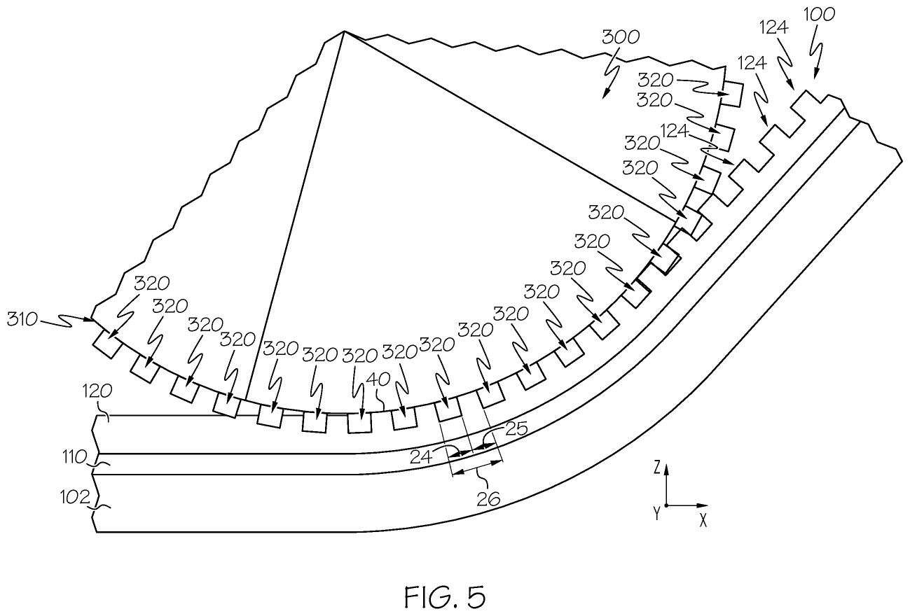

Referring to FIG. 5, an enlarged view of the arc length 40 of the replication roller 300 is depicted in contact with the optical resin layer 120. As shown in FIG. 5, individual projections of the plurality of projections 320 are pressed into the optical resin layer 120 along the arc length 40 as the glass web 102 moves in the conveyance direction 107. As the plurality of projections 320 are pressed into the optical resin layer 120, individual projections of the plurality of projections 320 cause the optical resin layer 120 to deform, forming the ribs 124 into the optical resin layer 120. In particular, the plurality of ribs 124 of the wire grid polarizer 100 correspond to and are complementary with the plurality or projections 320 of the replication roller 300, and are formed through pressing the plurality of projections 320 into the optical resin layer 120. Each projection of the plurality of projections 320 includes a width 24 that corresponds to the width 18 of the ribs 124 (FIG. 2) of the optical resin layer 120. Similarly, individual projections of the plurality of projections 320 are separated from one another by a pitch 26 that corresponds to the pitch 20 of the ribs 124 (FIG. 2) of the optical resin layer 120. In some embodiments, the width 24 of individual projections of the plurality of projections 320 is the same as the width 18 of individual ribs of the plurality of ribs 124, and the pitch 26 between the individual projections of the plurality of projections 320 is the same as the pitch 20 between individual ribs of the plurality of ribs 124. In other embodiments, the optical resin layer 120 may shrink during processing, and the width 24 and the pitch 26 of the plurality of projections 320 is between about 1% and about 5% greater than the resultant width 18 and the resultant pitch 20 of the plurality of ribs 124 to accommodate the change in dimension of the optical resin. While in the embodiment depicted in FIG. 5 the plurality of projections 320 are depicted as including a rectangular cross-section or square shape, it should be understood that the plurality of projections 320 may include any suitable shape to form the plurality of ribs 120 on the wire grid polarizer 100, including, without limitation, a wave shape or triangular shape.

In embodiments, individual projections of the plurality of projections 320 are periodically spaced, and the pitches 26 between individual projections of the plurality of projections 320 are generally uniform when evaluated around the outer circumference 310 of the replication roller 300. For example, in embodiments, the gaps 25 may have a tolerance such that each of the gaps 25 between adjacent projections are less than or equal to about 10 μm, evaluated around the outer circumference 310 of the replication roller 300. In some embodiments, the gaps 25 have a tolerance such that each of the gaps 25 between adjacent projections may be less than or equal to about 1 μm, evaluated around the outer circumference 310 of the replication roller 300. In other embodiments, the gaps 25 have a tolerance such that each of the gaps 25 between adjacent projections may be less than or equal to about 0.5 μm, evaluated around the outer circumference 310 of the replication roller 300.

Around the outer circumference 310 of the replication roller 300, individual gaps 25 between individual projections of the plurality of projections 320 may also be generally uniform in an axial direction across the replication roller 300 (depicted in FIG. 5 as the lateral direction), such that the plurality of projections 320 are generally parallel. For example, in one embodiment, the gaps 25 may have a tolerance such that no gap 25 has any portion of the gap 25 with an average width greater than about 10 μm, where the portion with the average width greater than about 10 μm extends more than about 10 μm in the axial direction. In another embodiment, the gaps 25 may have a tolerance such that no gap 25 has any portion of the gap 25 with an average width greater than about 1 μm, where the portion with the average width greater than about 1 μm extends more than about 10 μm in the axial direction. In another embodiment, the gaps 25 may have a tolerance such that no gap 25 has any portion of the gap with an average width greater than about 0.5 μm, where the portion with the width greater than about 0.5 μm extends more than about 10 μm in the axial direction.

Limiting the tolerance of the gaps 25 between individual projections of the plurality of projections 320 of the replication roller 300, the replication roller 300 may appear “seamless.” That is, the pattern of the plurality of projections 320 is uniform over the surface of the replication roller. In so doing, the plurality of projections of the replication roller 300 may form the plurality of ribs 124 on the wire grid polarizer 100 such that the plurality of ribs 124 are periodically spaced with limited tolerance in the gaps 22 (FIG. 2) between individual ribs of the plurality of ribs 124, thereby limiting defects, such as defects that may be visible when the wire grid polarizer 100 is utilized in an LCD. Further, a wire grid polarizer 100 formed by multiple revolutions of the replication roller 300 may be appear “seamless” due to the tight tolerances of the roller.

Referring again to FIG. 4, once the plurality of projections 320 of the replication roller 300 are pressed into the optical resin layer 120, the optical resin layer 120 is cured on the glass web 102 and/or the tie coat layer 110. In the embodiment depicted in FIG. 4, a curing lamp 340 may be used to direct energy 52, such as ultraviolet light, toward the optical resin layer 120 to cure the optical resin layer 120 to the glass web 102 and/or the tie coat layer 110. In particular, the curing lamp 340 directs energy 52 toward the optical resin layer 120 subsequent to and/or concurrently with the plurality of projections of the replication roller 300 forming the ribs 124 into the optical resin layer. In some embodiments, the optical resin layer 120 and the optional tie coat layer 110, if present, may be cured from the back side 103 of the glass web 102, although in further embodiments, the optical resin layer and the optional tie coat layer may be cured directly. While the optical resin layer 120 is described and depicted as being cured by a curing lamp that emits ultraviolet light, it should be understood that the optical resin layer 120 may be cured by any suitable curing method appropriate to the particular optical resin selected, including, but not limited to the application of electron beams, heat, or chemical additives.

Referring again to FIG. 2, once the plurality of ribs 124 have been formed into the optical resin layer 120 and the optical resin layer 120 has been cured on the glass web 102 and/or the tie coat layer 110, the plurality of reflectors 130 are applied to the ribs 124 of the optical resin layer 120. In embodiments, the plurality of reflectors 130 are applied to the ribs 124 of the optical resin layer 120 through off-axis sputtering deposition, that may minimize the amount of conductive material that is applied to the base portion 122 of the optical resin layer 120. By minimizing the amount of conductive material that is applied to the base portion 122 of the optical resin layer 120, the conductive material that is applied to the optical resin layer 120 may be primarily applied to the ribs 124, as opposed to the base portion 122. Subsequent to the application of conductive material to form the reflectors 130, any conductive material that may have been inadvertently applied to the base portion 122 of the optical resin layer 120 may be removed, for example by an etching process. As the conductive material is primarily applied to the ribs 124, the wire grid polarizer 100 may be etched for a period of time sufficient to remove any conductive material from the base portion 122, while retaining conductive material on the ribs 124 to form the reflectors 130.

Once the reflectors 130 have been applied to the wire grid polarizer 100, the wire grid polarizer 100 may be cut in the lateral direction to form separate wire grid polarizers 100. In some embodiments, the wire grid polarizer 100 may be taken up by an output spool (not depicted).

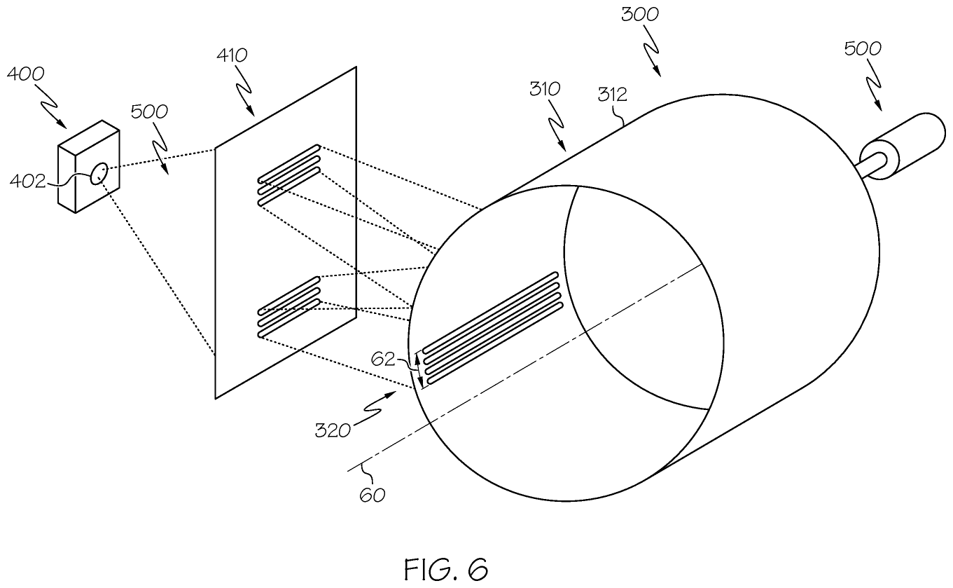

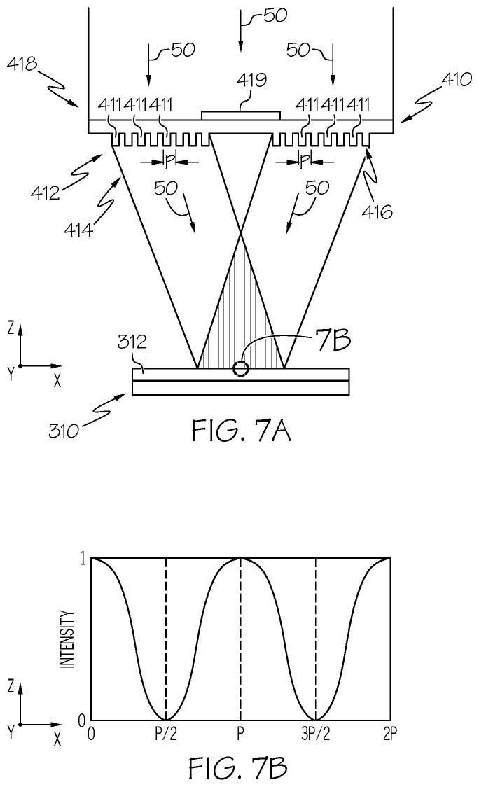

Methods of forming the replication roller 300 and plurality of projections 320 on the replication roller 300 will now be described in detail with reference to FIGS. 6-7B.

As shown in FIGS. 6-7B, the plurality of projections 320 on the replication roller 300 are formed using a phase-mask lithography process. The outer circumference 310 of the replication roller 300 is initially coated with a photoresist material to form a photoresist layer 312 on the outer circumference 310 of the replication roller 300.

To form the plurality of projections 320 in the photoresist layer 312, an emitter 400, such a 365 nm I-line lamp, emits electromagnetic radiation 50 through a pin-hole aperture 402 toward a phase-shift mask 410. As the electromagnetic radiation 50 passes through the phase-shift mask 410, the phase-shift mask 410 induces a phase shift of the electromagnetic radiation 50, as will be described in greater detail herein.

Referring to FIG. 7A, an enlarged view of the phase-shift mask 410 and a portion of the outer circumference 310 of the replication roller 300 is depicted. The phase-shift mask 410 includes a light transmissive substrate 418 including a plurality of transmission gratings 412 on a surface of the phase-shift mask 410. The substrate 418 may be light transmissive, such that the substrate 418 permits at least an 85% optical transmission of wavelengths across 85% of the visible spectrum. As the electromagnetic radiation 50 passes through the phase-shift mask 410, the phase of the electromagnetic radiation 50 shifts such that certain wavelengths of electromagnetic radiation 50 constructively interfere with one another and other waves of electromagnetic radiation 50 destructively interfere with one another. While in the embodiment depicted in FIG. 7A, the first transmission grating 414 and the second transmission grating 416 are depicted as including arrays of individual features 411 including a rectangular cross-section or square shape, it should be understood that the first transmission grating 414 and the second transmission grating 416 may include arrays of individual features 411 of any suitable shape to induce constructive and destructive interference in the electromagnetic radiation 50, including, but not limited to, wave shaped or triangular shaped individual features.

As depicted in FIG. 7A, the phase-shift mask 410 includes a first transmission grating 414 and a second transmission grating 416 that is spaced apart from the first transmission grating 414. In the embodiment depicted in FIG. 7A, the phase-shift mask 410 includes an opaque portion 419 positioned between the first transmission grating 414 and the second transmission grating 416. The phase shift mask 410 may prevent transmission of the electromagnetic radiation 50 between the first transmission grating 414 and the second transmission grating 416. By utilizing a first transmission grating 414 and a second transmission grating 416, the constructive and destructive interference of the electromagnetic radiation 50 may be increased. In particular, electromagnetic radiation 50 passed through the first transmission grating 414 may constructively and destructively interfere with electromagnetic radiation 50 passed through the second transmission grating 416.

Referring to FIG. 7B, the intensity of the electromagnetic radiation 50 incident on the photoresist layer 312 is increased where the waves of electromagnetic radiation 50 constructively interfere with one another. Conversely, the intensity of the electromagnetic radiation 50 incident on the photoresist layer 312 may be decreased and may be at or near zero where the waves of electromagnetic radiation 50 destructively interfere with one another. In this way, portions of the photoresist layer 312 are exposed to electromagnetic radiation 50 at a first intensity where the waves of the electromagnetic radiation 50 constructively interfere with one another, while other portions of the photoresist layer 312 are exposed to electromagnetic radiation 50 with a second intensity that is less than the first intensity where the waves of the electromagnetic radiation 50 destructively interfere with one another. In embodiments, the second intensity may be at or near zero where the waves of the electromagnetic radiation 50 destructively interfere with one another.

As shown in FIG. 6, once one portion of the outer circumference 310 of the replication roller 300 has been exposed to the electromagnetic radiation 50, the replication roller 300 may be rotated, and the process may be repeated until the entirety of the outer circumference 310 has been exposed to the electromagnetic radiation 50 through the phase-shift mask 410. In embodiments, the outer circumference 310 of the replication roller 300 may be relatively small to reduce the number of exposures required to form the plurality of projections 320. For example, in one embodiment, the outer circumference 310 of the replication roller is about 64 cm. In embodiments, the outer circumference 310 of the replication roller 300 may be between about 40 cm and about 90 cm. In other embodiments, the outer circumference of the replication roller 300 is between about 60 cm and about 70 cm.

In some embodiments, a motor 500 is coupled to the replication roller 300 and may rotate the replication roller 300 about an axis 60 between exposures. The motor 500 may control angular rotation of a shaft of the motor, and may include a gear motor with an encoder, a stepper motor, or the like. Once a portion of the outer circumference 310 of the replication roller 300 has been exposed, the motor 500 may rotate the replication roller 300 by a predetermined angular distance that corresponds to an arc length 62 of the exposed portion of the outer circumference 310 of the replication roller 300. By rotating the replication roller by a predetermined angular distance that corresponds to the arc length 62, the motor 500 may assist in limiting discontinuities between portions of the outer circumference 310 that are exposed to the electromagnetic radiation 50. In so doing, the motor 500 may assist in limiting discontinuities in the pitch 26 and the width 24 of the plurality of projections 320, such that the pitch 26 and the width 24 of the plurality of projections 320 are generally uniform around the outer circumference 310 of the replication roller 300.

In some embodiments, instead of rotating the replication roller by a fixed angular rotation, the motor 500 may selectively rotate the replication roller 300 by a variable angular rotation to accommodate fluctuations in the outer circumference 310 of the replication roller, such as may result from temperature changes. In particular, temperature fluctuations may cause the outer circumference 310 of the replication roller to expand or contract, either one of which may affect the arc length 62 of the outer circumference 310 that is exposed during each exposure. In embodiments, once a portion of the outer circumference 310 has been exposed to electromagnetic radiation 50, polymerization of the photoresist layer 312 at the exposed portion may cause dimensional change, such that a thickness of the photoresist layer 312 at the exposed portion may be less than a thickness of the photoresist layer 312 at portions of the outer circumference 310 that were not exposed to the electromagnetic radiation 50. The difference in thickness between the exposed portions and the unexposed portions of the photoresist layer 312 may be detected, such as through a helium-neon laser (not depicted), and accordingly, a helium-neon laser may be used to detect the boundary between the arc length 62 of the exposed portion of the outer circumference 310 and portions of the outer circumference 310 that have not been exposed to the electromagnetic radiation 50. By detecting the boundary of the arc length 62, the motor 500 may selectively rotate the replication roller 300 based on the detected boundary of the arc length 62 to limit misalignment between subsequently exposed portions of the outer circumference 310.

In embodiments where the photoresist layer 312 is formed from a positive resist, the portions of the photoresist layer 312 exposed to the first intensity of electromagnetic radiation 50 become soluble in a particular solvent upon exposure to the electromagnetic radiation 50. Alternatively, the photoresist layer 312 may initially be soluble and the portions of the photoresist layer 321 that are exposed to the first intensity of electromagnetic radiation 50 become insoluble in a particular solvent upon exposure to the electromagnetic radiation 50, such as when the photoresist layer 312 is formed from a negative resist. In either instance, once the photoresist layer 312 has been exposed to the electromagnetic radiation 50, the soluble portions of the photoresist layer 312 may be removed, such as with the particular solvent, leaving behind the insoluble portions of the photoresist layer 312 that form the projections 320 of the replication roller 300.

Referring again to FIGS. 7A and 7B, through the constructive and destructive interference of the waves of the electromagnetic radiation 50, a distance between portions of the photoresist layer 312 exposed to the first intensity of electromagnetic radiation 50, or relatively high intensity electromagnetic radiation 50, may be as small as ½ of a pitch p between individual features 411 of the of transmission gratings 412. For example, by using a phase-shift mask 410 including a first transmission grating 414 and a second transmission grating 416, the distance between portions of the photoresist layer 321 exposed to the first intensity of electromagnetic radiation 50 may be further reduced to be as small as ¼ of the pitch p between individual features 411 of the transmission gratings 412. Accordingly, in example embodiments where the pitch p between individual features 411 of the transmission gratings 412 is 400 nm, the phase-shift mask 410 may facilitate constructive and destructive interference between the waves of electromagnetic radiation 50 such that the distance between portions of the photoresist layer 321 exposed to the first intensity of electromagnetic radiation 50 may be as small as 100 nm. In such embodiments, the pitch between individual projections (FIG. 5) may also be as small as 100 nm such that the projections 320 of the replication roller 300 form the ribs 124 of the wire grid polarizer 100 shown in FIG. 2.

By forming the plurality of projections 320 directly onto the replication roller 300 through a phase-mask lithography process, as compared to applying a separate member to the replication roller to form the plurality of projections 320, the plurality of projections 320 may maintain a circularity tolerance. In particular, in embodiments, the circularity tolerance of the plurality of projections 320 of the replication roller 300 is less than about 1 μm. In other words, none of the individual projections extend radially outward from a central axis of the replication roller 300 by a distance that is greater than 1 μm farther than any other of the individual projections of the plurality of projections 320, when evaluated around the outer circumference 310 of the replication roller 300. By maintaining a circularity tolerance of less than about 1 μm for the plurality of projections 320 of the replication roller 300, the replication roller 300 may maintain the flatness tolerance of the wire grid polarizer 100 when the plurality of ribs 124 (FIG. 2) are formed, thereby reducing defects that may be visible when the wire grid polarizer 100 is utilized in an LCD, as described above.

It should now be understood that wire grid polarizers may be fabricated on a glass web by depositing an optical resin layer on the glass web and forming ribs on the optical resin layer with a replication roller. Reflectors may later be deposited on the ribs to form the wire grid polarizer. In embodiments, the replication roller includes a plurality of projections that extend around the outer circumference of the replication roller. Through contact with the optical resin layer, the replication roller may be utilized to continuously form ribs onto the optical resin layer, which may allow for the continuous fabrication of wire grid polarizers. A phase-mask lithography process may be utilized to form the plurality of projections on the outer circumference of the wire grid polarizer such that a width of and a pitch between individual projections of the plurality of projections on the replication roller correspond to the ribs of the wire grid polarizer. By utilizing a replication roller formed using a phase-mask lithography process, dimensional tolerances of the ribs of the wire grid polarizer and the flatness of the wire grid polarizer may be controlled, thereby reducing non-compliant parts and manufacturing costs.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

1. A method for forming a wire grid polarizer, the method comprising:
applying an optical resin layer to a surface of a glass web;
contacting the optical resin layer with an outer circumference of a replication roller comprising a plurality of projections extending around at least a portion of the outer circumference; and
curing the optical resin layer.

2. The method of claim 1, further comprising applying a tie coat layer to the glass web prior to applying the optical resin layer, the tie coat layer positioned between the glass web and the optical resin layer.

3. The method of claim 1, further comprising depositing a reflective material on the optical resin layer.

4. The method of claim 1, further comprising directing the glass web around at least a portion of the outer circumference of the replication roller such that the optical resin layer contacts the outer circumference of the replication roller along an arc length of the outer circumference less than the entire outer circumference.

5. The method of claim 1, wherein contacting the optical resin layer further comprises forming a plurality of ribs in the optical resin layer, wherein individual ribs of the plurality of ribs are spaced apart from one another by a pitch that is between about 40 nm and 240 nm, and wherein the individual ribs of the plurality of ribs define gaps between adjacent ribs equal to or less than 10 μm over a length of the wire grid polarizer.

6. The method of claim 5, wherein the plurality of ribs comprise a rectangular cross-section.

7. The method of claim 1, wherein the curing comprises exposing the optical resin layer to electromagnetic radiation through a backside of the glass web.

8. The method of claim 1, further comprising:
melting batch materials to form molten glass;
forming the molten glass into the glass web; and
moving the glass web in a conveyance direction.

9. A wire grid polarizer comprising:
a glass web;
an optical resin layer positioned over at least a portion of the glass web, the optical resin layer comprising:
a base portion; and
a plurality of ribs extending from the base portion, wherein individual ribs of the plurality of ribs are spaced apart from one another by a pitch that is between about 40 nm and 240 nm, and wherein the individual ribs of the plurality of ribs define gaps between adjacent ribs and each gap is equal to or less than 10 μm over a length of the wire grid polarizer.

10. The wire grid polarizer of claim 9, wherein the length of the wire grid polarizer is greater than 127 cm.

11. The wire grid polarizer of claim 9, wherein a CTE of the glass web is between about 1 ppm/° C. and about 5 ppm/° C.

12. The wire grid polarizer of claim 9, wherein a thickness of the glass web is between about 100 nm and about 200 nm.

13. The wire grid polarizer of claim 9, wherein the pitch between the individual ribs of the plurality of ribs is about 200 nm.

14. The wire grid polarizer of claim 9, wherein none of the gaps are greater than 1 μm over the length of the wire grid polarizer.

15. The wire grid polarizer of claim 9, wherein a flatness tolerance of the wire grid polarizer evaluated between a bottom surface of the glass web and a top surface of the plurality of ribs over the length of the wire grid polarizer is less than about 1 μm.

16. The wire grid polarizer of claim 9, further comprising a tie coat layer positioned between the glass web and the optical resin layer.

17. The wire grid polarizer of claim 9, wherein a width of the individual ribs of the plurality of ribs is between about 20 nm and 120 nm.

18. The wire grid polarizer of claim 9, wherein a width of the individual ribs of the plurality of ribs is about 100 nm.

19. The wire grid polarizer of claim 9, wherein the plurality of ribs comprise a rectangular cross-section.

20-31. (canceled)
